(19) United States
(12) Patent Application Publication
(10) Pub. No.: US 2018/0197680 A1
(43) Pub. Date: Jul. 12, 2018

(54) METHOD FOR IMPROVEMENT OF MAGNETIC PERFORMANCE OF SINTERED NDFEB LAMELLAR MAGNET

(71) Applicants: NINGBO YUNSHENG CO.,LTD., Zhejiang (CN); NINGBO YUNSHENG MAGNET DEVICES TECHNOLOGY CO., LTD., Zhejiang (CN)

(72) Inventors: Qingzhong YANG, Zhejiang (CN); Gaoyang SHI, Zhejiang (CN); Min ZHANG, Zhejiang (CN); Yong DING, Zhejiang (CN); Xiangke LV, Zhejiang (CN); Yiqun HU, Zhejiang (CN)

(73) Assignees: NINGBO YUNSHENG CO.,LTD., Zhejiang (CN); NINGBO YUNSHENG MAGNET DEVICES TECHNOLOGY CO., LTD, Zhejiang (CN)

(21) Appl. No.: 15/742,032

(22) PCT Filed: Jul. 12, 2016
(86) PCT No.: PCT/CN2016/000377

§ 371 Date: Jan. 5, 2018

(30) Foreign Application Priority Data
Dec. 25, 2015 (CN) 201510997488.4

(51) Int. Cl. H01F 41/02; H01F 1/057

(52) U.S. Cl. CPC H01F 41/0293; H01F 1/0577

(57) ABSTRACT

A method for improvement of a magnetic performance of sintered NdFeB lamellar magnet includes the following steps. A powder containing rare earth elements is to be coated on a surface of the sintered NdFeB lamellar magnet to form a top coat. After that, proceed with diffusion treatment and aging treatment to make rare earth elements as contained in the top coat come into the sintered NdFeB lamellar magnet. The powder containing rare earth elements belongs to the mixture of powder of rare earth oxide and hydrogen storage alloy hydride.

### BACKGROUND OF THE INVENTION

### 1. Field of the Invention

The present invention generally relates to a method for improvement of magnetic performance of sintered NdFeB magnet, in particular, to a method for improvement of magnetic performance of sintered NdFeB lamellar magnet.

### 2. Description of Related Art

Sintered NdFeB magnet has excellent and comprehensive magnetic performance, which has been extensively applied to such fields as aeronautics and astronautics, microwave communication technologies, auto industry, instrumentation as well as medical apparatuses and instruments. In recent years, application market of high-performance sintered NdFeB has been in a quick development towards small, light and thin products. Promotion and application of sintered NdFeB lamellar magnet (sintered NdFeB magnet with thickness below 15 mm) has witnessed a quick expansion in such high-end fields as wind power generation, VF compressor and hybrid power. Meanwhile, the market has put forward higher requirements for its performance, such as higher remanence and coercive.

Traditional method for improvement of coercive of sintered NdFeB lamellar magnet is to add such heavy rare earth elements as Dy or Tb. Such heavy rare earth elements as Dy or Tb are added through addition of metals or alloys containing such heave rare earth elements as Dy or Tb during melting, or through dual alloys method. However, most of heavy rare earth elements added with such method will come into the main phase of NdFeB, and only few of them will be distributed on the grain boundary; this may result in low utilization rate of heavy rare earth elements. Meanwhile, a large quantity of such heavy rare earth elements in the main phase may result in significant reduction in remanence and maximum magnetic energy product of sintered NdFeB lamellar magnet.

To prevent significant reduction in maximum magnetic energy product during improvement of coercivity of sintered NdFeB lamellar magnet, the grain boundary diffusion method is currently used to improve performance of sintered NdFeB lamellar magnet. According to this method, rare earth powder or rare earth compound is to be coated on the surface of sintered NdFeB lamellar magnet to form a top coat. After that, proceed with diffusion treatment and aging treatment to make rare earth elements as contained in the top coat come into the sintered NdFeB lamellar magnet. Wherein, coating methods include spray coating, dipping, evaporation, magnetron sputtering or electroplating and so on. According to this method, rare earth elements coming into the sintered NdFeB lamellar magnet are mainly distributed on the grain boundary of the sintered NdFeB lamellar magnet and epitaxial layer of main phase. This can improve coercivity of sintered NdFeB lamellar magnet, and prevent significant reduction of remanence. However, there are following problems with such method: When rare earth powder is used, rare earth elements are apt to come into the sintered NdFeB lamellar magnet during diffusion. Despite of the fact that coercivity can be significantly improved when reduction of remanence is insignificant, rare earth metal powder may become instable in the air environment, which requires atmosphere protection during storage and formation of top coat; therefore, it is unavailable for mass production. Rare earth compound powder used can improve stability of earth compound in the air environment, which requires no atmosphere protection during storage and formation of top coat. Nevertheless, rare earth compound is not easy for decomposition during diffusion, which may make it difficult for rare earth elements to come into the sintered NdFeB lamellar magnet to result in insignificant improvement of its coercivity. Meanwhile, this may also affect squareness of final sintered NdFeB lamellar magnet.

### SUMMARY OF THE INVENTION

The technical issue to be solved by the present invention is to provide a method for improvement of magnetic performance of sintered NdFeB lamellar magnet. Such method can prevent significant reduction of remanence while improving the coercivity. It is available for mass production, which will not affect squareness of final sintered NdFeB lamellar magnet.

Technical solution used by the present invention to solve aforesaid technical issue is stated as follows: A method for improvement of magnetic performance of sintered NdFeB lamellar magnet: Rare earth metal powder or rare earth compound is to be coated on the surface of sintered NdFeB lamellar magnet to form a top coat; after that, proceed with diffusion treatment and aging treatment to make rare earth elements as contained in the top coat come into the sintered NdFeB lamellar magnet; the powder containing rare earth elements belongs to the mixture of powder of rare earth oxide and hydrogen storage alloy hydride.

In the powder containing rare earth elements, mass percentage of the rare earth oxide powder and the hydrogen storage alloy hydride powder is 70%˜99.9% and 0.1%˜30% respectively. It is applicable to ensure effective control of release of hydrogen gas in the hydrogen storage alloy hydride during diffusion by controlling mass percentage of powder of rare earth oxide and hydrogen storage alloy hydride; this can also prevent excessive hydrogen from coming into the sintered NdFeB lamellar magnet, and thereby eliminate adverse effect on the mechanical property of sintered NdFeB lamellar magnet.

The rare earth oxide is composed of one or at least two mixtures of oxide of scandium, yttrium and lanthanide.

The rare earth oxide is composed of one or at least two mixtures of oxide of dysprosium, terbium and holmium. According to this method, the oxide of dysprosium, terbium and holmium is stable in the air environment, which may come into the grain boundary of sintered NdFeB lamellar magnet and epitaxial layer of main phase through occurring oxidation-reduction reaction with hydrogen storage alloy hydride to ensure significant improvement of coercivity.

The hydrogen storage alloy hydride is composed of one or at least two mixtures of alkali hydride, alkali alloy hydride, alkali earth metal hydride, alkali earth metal alloy hydride, rare earth hydride and rare earth alloy hydride. According to this method, hydrogen storage hydride is easy to release hydrogen gas during diffusion heat treatment, which may create a reduction atmosphere to facilitate further grain boundary diffusion.

The hydrogen storage hydride is composed of one or at least two mixtures of alkali earth metal hydride and rare earth hydride.

Average grain size per specific area of the rare earth oxide powder is≤10 μm. According to this method, rare earth oxide powder has smaller grain size for full contact with the surface of sintered NdFeB lamellar magnet, which is favorable for easy diffusion of rare earth elements into the sintered NdFeB lamellar magnet and improvement of utilization rate of rare earth.

Average grain size per specific area of the hydrogen storage alloy hydride powder is≤2 mm.

Average grain size per specific area of the hydrogen storage alloy hydride powder is≤100 μm. According to this method, when grain size of hydrogen storage alloy hydride powder is below 100 μm, hydrogen storage alloy hydride powder will be in full contact with rare earth oxide powder to ensure more thorough reaction between the hydrogen released by hydrogen storage alloy hydride during follow-up diffusion heat treatment and rare earth oxide, this is favorable for diffusion of rare earth elements in the sintered NdFeB lamellar magnet.

The diffusion treatment refers to heat preservation for 1 h-30 h at the temperature of 700° C.˜1000° C. ; the aging treatment refers to heat preservation for 1 h-10 h at the temperature of 400° C.˜600° C.

As compared with prior arts, the present invention has the following features: powder containing rare earth elements is to be coated on the surface of sintered NdFeB lamellar magnet to form a top coat; after that, proceed with diffusion treatment and aging treatment to make rare earth elements as contained in the top coat come into the sintered NdFeB lamellar magnet; the powder containing rare earth elements is the mixture of rare earth oxide powder and hydrogen storage alloy hydride powder; material of the top coat formed on the surface of sintered NdFeB lamellar magnet is the mixture of rare earth oxide powder and hydrogen storage alloy hydride powder; mixture of rare earth oxide powder and hydrogen storage alloy hydride powder has stable property in the air environment; the formation process of top coat is easy for operation; rare earth oxide in the top coat will be in oxidation-reduction reaction with hydrogen storage alloy hydride during heated diffusion treatment to the sintered NdFeB lamellar magnet; rare earth elements in the rate earth oxide will be reduced; rare earth elements that are easy for diffusion will be formed on the surface of sintered NdFeB lamellar magnet; hydrogen storage alloy hydride will produce hydrogen gas during heated diffusion treatment; sintered NdFeB lamellar magnet will be in the atmosphere for hydrogen reduction; rare earth elements diffused into the sintered NdFeB lamellar magnet will not be oxidized again by oxygen element in the sintered NdFeB lamellar magnet; this can ensure diffusion of rare earth elements into the sintered NdFeB lamellar magnet other than stay at the internal part adjacent to the surface; in this way, it can significantly improve diffusion efficiency of rare earth elements, increase the diffusion depth of rare earth elements, and minimize the difference to the content of rare earth elements at different parts inside the sintered NdFeB lamellar magnet; this can prevent significant reduction in remanence while improving the coercivity; moreover, it is available for mass production, which will not affect squareness of final sintered NdFeB lamellar magnet.

### DESCRIPTION OF THE EMBODIMENTS

The present invention is further described as follows in combination with embodiments:

### Embodiment 1

A method for improvement of magnetic performance of sintered NdFeB lamellar magnet includes the following steps:

\textcircled{1} Preparation of turbid liquid containing rare earth elements: the turbid liquid containing rare earth elements will be produced through mixing of Dy₂O₃ powder and CaH₂ powder for uniform distribution in the ethanol absolute; mass ratio between Dy₂O₃ powder and CaH₂ powder is 3:1;

\textcircled{2} Uniformly spray turbid liquid containing rare earth elements on the surface of sintered NdFeB lamellar magnet, ensure preliminary surface treatment to the sintered NdFeB lamellar magnet prior to spray coating;

\textcircled{3} Proceed with drying treatment to sintered NdFeB lamellar magnet after spray coating; drying treatment refers to heat preservation for 5 minutes at the temperature of 60° C., store sintered NdFeB lamellar magnet in the atmosphere of inert gas after drying treatment;

\textcircled{4} Proceed with diffusion treatment to the sintered NdFeB lamellar magnet as dried in the vacuum environment at the pressure of 5×10⁻⁴ Pa prior to aging treatment; diffusion treatment temperature is 900° C.; diffusion treatment time is 12 h; aging treatment temperature is 500° C.; aging treatment time is 4 h.

In this embodiment, sintered NdFeB lamellar magnet is made from massive sintered NdFeB magnet through mechanical processing (cutting); its specification (diameter×thickness) is Φ10×7 mm; massive sintered NdFeB magnet is prepared based on such well-established processes as strip casting, hydrogen decrepitation, jet milling, pressing and sintering in the field of NdFeB fabrication; sintered NdFeB lamellar magnet includes the following constituents: Nd with mass percentage up to 24.5%, Dy with mass percentage up to 0.2%, Pr with mass percentage up to 4.8%, B with mass percentage up to 1.0%, residual Fe and other micro elements.

Mark the sintered NdFeB lamellar magnet before spray coating with the method in this embodiment as original sample; select two sintered NdFeB lamellar magnets as prepared with the method in this embodiment, and mark them as test sample 1-1 and 1-2; select B-H instrument for measurement of permanent magnet material to carry out magnetic performance test for original sample and test sample 1-1 and 1-2 respectively; magnetic performance test data is as shown in Table 1.

TABLE 1
Results of Performance Test for Sintered
NdFeB Lamellar Magnet in Embodiment 1

| | | | Maximum | |
|---|---|---|---|---|
| | | | Magnetic | |
| | | Intrinsic | Energy | |
| | Remanence | Coercivity | Product | |
| | (KGs) | (KOe) | (MGsOe) | Squareness |
| Original sample | 13.99 | 14.88 | 46.61 | 0.96 |
| Test sample 1-1 | 13.93 | 18.58 | 46.56 | 0.949 |
| Test sample 1-2 | 13.95 | 18.7 | 46.77 | 0.949 |

It can be seen from analysis of Table 1 that the mixture coated with Dy₂O₃ powder and CaH₂ powder has witnessed a significant improvement of magnet coercivity by 3.5˜4 kOe approximately through grain boundary diffusion on the surface of sintered NdFeB lamellar magnet at the limited loss of remanence; moreover, sintered NdFeB lamellar has excellent consistency of magnetic performance.

### Embodiment 2

A method for improvement of magnetic performance of sintered NdFeB lamellar magnet includes the following steps:

\textcircled{1} Preparation of turbid liquid containing rare earth elements: The turbid liquid containing rare earth elements will be produced through mixing of Tb₂O₃powder and CaH₂ powder for uniform distribution in the ethanol absolute; mass ratio between Tb₂O₃ powder and CaH₂ powder is 3:1;

\textcircled{2} Uniformly spray turbid liquid containing rare earth elements on the surface of sintered NdFeB lamellar magnet; ensure preliminary surface treatment to the sintered NdFeB lamellar magnet prior to spray coating;

\textcircled{3} Proceed with drying treatment to sintered NdFeB lamellar magnet after spray coating; drying treatment refers to heat preservation for 5 minutes at the temperature of 60° C.; store sintered NdFeB lamellar magnet in the atmosphere of inert gas after drying treatment;

\textcircled{4} Proceed with diffusion treatment to the sintered NdFeB lamellar magnet as dried in the vacuum environment at the pressure of 5×10⁻⁴ Pa prior to aging treatment; diffusion treatment temperature is 900° C.; diffusion treatment time is 12 h; aging treatment temperature is 500° C.; aging treatment time is 4 h.

In this embodiment, sintered NdFeB lamellar magnet is made from massive sintered NdFeB magnet through mechanical processing (cutting); its specification (diameter×thickness) is Φ10×7 mm; massive sintered NdFeB magnet is prepared based on such well-established processes as strip casting, hydrogen decrepitation, jet milling, pressing and sintering in the field of NdFeB fabrication; sintered NdFeB lamellar magnet includes the following constituents: Nd with mass percentage up to 24.5%, Dy with mass percentage up to 0.2%, Pr with mass percentage up to 4.8%, B with mass percentage up to 1.0%, residual Fe and other micro elements.

Mark the sintered NdFeB lamellar magnet before spray coating with the method in this embodiment as original sample; select two sintered NdFeB lamellar magnets as prepared with the method in this embodiment, and mark them as test sample 2-1 and 2-2; select B-H instrument for measurement of permanent magnet material to carry out magnetic performance test for original sample and test sample 2-1 and 2-2 respectively; magnetic performance test data is as shown in Table 2.

TABLE 2
Results of Performance Test for Sintered
NdFeB Lamellar Magnet in Embodiment 2

| | | | Maximum | |
|---|---|---|---|---|
| | | | Magnetic | |
| | | Intrinsic | Energy | |
| | remanence | Coercivity | Product | |
| | (KGs) | (KOe) | (MGsOe) | Squareness |
| Original sample | 13.99 | 14.88 | 46.61 | 0.96 |
| Test sample 2-1 | 13.88 | 21.93 | 46.12 | 0.951 |
| Test sample 2-2 | 13.85 | 22.12 | 46.1 | 0.95 |

It can be seen from analysis of Table 2 that the mixture coated with Tb₂O₃ powder and CaH₂ powder has witnessed a significant improvement of magnet coercivity by 7˜7.5 kOe approximately through grain boundary diffusion on the surface of sintered NdFeB lamellar magnet at the limited loss of remanence; moreover, sintered NdFeB lamellar has excellent consistency of magnetic performance.

### Embodiment 3

A method for improvement of magnetic performance of sintered NdFeB lamellar magnet includes the following steps:

\textcircled{1} Preparation of turbid liquid containing rare earth elements: The turbid liquid containing rare earth elements will be produced through mixing of Dy₂O₃ powder and CaH₂ powder for uniform distribution in the ethanol absolute; mass ratio between Tb₂O₃ powder and CaH₂ powder is 3:1;

\textcircled{2} Dip the sintered NDFeB lamellar magnet in the turbid liquid containing rare earth elements for ultrasonic treatment; be sure to carry out preliminary surface treatment to the sintered NDFeB lamellar magnet prior to dipping;

\textcircled{3} Proceed with drying treatment to sintered NdFeB lamellar magnet after spray coating; drying treatment refers to heat preservation for 10 minutes at the temperature of 60° C.; store sintered NdFeB lamellar magnet in the atmosphere of inert gas after drying treatment;

\textcircled{4} Proceed with diffusion treatment to the sintered NdFeB lamellar magnet as dried in the vacuum environment at the pressure of 5×10⁻⁴ Pa prior to aging treatment; diffusion treatment temperature is 900° C.; diffusion treatment time is 12 h; aging treatment temperature is 500° C.; aging treatment time is 4 h.

In this embodiment, sintered NdFeB lamellar magnet is made from massive sintered NdFeB magnet through mechanical processing (cutting); its specification (diameter×thickness) is Φ10×7 mm; massive sintered NdFeB magnet is prepared based on such well-established processes as strip casting, hydrogen decrepitation, jet milling, pressing and sintering in the field of NdFeB fabrication; sintered NdFeB lamellar magnet includes the following constituents: Nd with mass percentage up to 24.5%, Dy with mass percentage up to 0.2%, Pr with mass percentage up to 4.8%, B with mass percentage up to 1.0%, residual Fe and other micro elements.

Mark the sintered NdFeB lamellar magnet before spray coating with the method in this embodiment as original sample; select two sintered NdFeB lamellar magnets as prepared with the method in this embodiment, and mark them as test sample 3-1 and 3-2; select B-H instrument for measurement of permanent magnet material to carry out magnetic performance test for original sample and test sample 3-1 and 3-2 respectively; magnetic performance test data is as shown in Table 3.

TABLE 3
Results of Performance Test for Sintered
NdFeB Lamellar Magnet in Embodiment 3

| | | | Maximum | |
|---|---|---|---|---|
| | | | Magnetic | |
| | | Intrinsic | Energy | |
| | remanence | Coercivity | Product | |
| | (KGs) | (KOe) | (MGsOe) | Squareness |
| Original sample | 13.99 | 14.88 | 46.61 | 0.96 |
| Test sample 3-1 | 13.92 | 18.38 | 46.20 | 0.935 |
| Test sample 3-2 | 13.94 | 18.44 | 46.32 | 0.941 |

It can be seen from analysis of Table 3 that the mixture coated with Dy2O3 powder and CaH₂ powder has witnessed a significant improvement of magnet coercivity by 3.5˜4 kOe approximately through grain boundary diffusion on the surface of sintered NdFeB lamellar magnet at the limited loss of remanence; moreover, sintered NdFeB lamellar has excellent consistency of magnetic performance. As proved, method used by the present invention can be used to different coating processes.

### Embodiment 4

A method for improvement of magnetic performance of sintered NdFeB lamellar magnet includes the following steps:

\textcircled{1} Preparation of turbid liquid containing rare earth elements: The turbid liquid containing rare earth elements will be produced through mixing of Dy₂O₃ powder and NaH powder for uniform distribution in the ethanol absolute; mass ratio between Tb₂O₃ powder and NaH powder is 3:1;

\textcircled{2} Uniformly spray turbid liquid containing rare earth elements on the surface of sintered NdFeB lamellar magnet; ensure preliminary surface treatment to the sintered NdFeB lamellar magnet prior to spray coating;

\textcircled{3} Proceed with drying treatment to sintered NdFeB lamellar magnet after spray coating; drying treatment refers to heat preservation for 5 minutes at the temperature of 60° C.; store sintered NdFeB lamellar magnet in the atmosphere of inert gas after drying treatment;

\textcircled{4} Proceed with diffusion treatment to the sintered NdFeB lamellar magnet as dried in the vacuum environment at the pressure of 5×10⁻⁴ Pa prior to aging treatment; diffusion treatment temperature is 900° C.; diffusion treatment time is 12 h; aging treatment temperature is 500° C.; aging treatment time is 4 h.

In this embodiment, sintered NdFeB lamellar magnet is made from massive sintered NdFeB magnet through mechanical processing (cutting); its specification (diameter×thickness) is Φ10×7 mm; massive sintered NdFeB magnet is prepared based on such well-established processes as strip casting, hydrogen decrepitation, jet milling, pressing and sintering in the field of NdFeB fabrication; sintered NdFeB lamellar magnet includes the following constituents: Nd with mass percentage up to 24.5%, Dy with mass percentage up to 0.2%, Pr with mass percentage up to 4.8%, B with mass percentage up to 1.0%, residual Fe and other micro elements.

### Embodiment 5

This embodiment is basically identical to Embodiment 4; the only difference is that the hydrogen storage hydride used in this embodiment is NdH₃.

### Embodiment 6

This embodiment is basically identical to Embodiment 4; the only difference is that the hydrogen storage hydride used in this embodiment is LiAlH₄.

### Embodiment 7

This embodiment is basically identical to Embodiment 4; the only difference is that the hydrogen storage hydride used in this embodiment is KBH₄.

Mark the sintered NdFeB lamellar magnet prepared with the method in Embodiment 4 as test sample 4; mark the sintered NdFeB lamellar magnet prepared with the method in Embodiment 5 as test sample 5; mark the sintered NdFeB lamellar magnet prepared with the method in Embodiment 6 as test sample 6; mark the sintered NdFeB lamellar magnet prepared with the method in Embodiment 7 as test sample 7; mark the sintered NdFeB lamellar magnet prior to spray coating as original sample. Select B-H instrument for measurement of permanent magnet material to carry out magnetic performance test for original sample 4-7 and test sample 4-7 respectively; magnetic performance test data is as shown in Table 4.

TABLE 4
Results of Performance Test for Sintered
NdFeB Lamellar Magnet in Embodiment 4-7

| | | | Maximum | |
|---|---|---|---|---|
| | | | Magnetic | |
| | | Intrinsic | Energy | |
| | remanence | Coercivity | Product | |
| | (KGs) | (KOe) | (MGsOe) | Squareness |
| Original sample | 13.99 | 14.88 | 46.61 | 0.96 |
| Test sample 4 | 13.93 | 18.10 | 46.22 | 0.935 |
| Test sample 5 | 13.90 | 18.93 | 46.32 | 0.941 |
| Test sample 6 | 13.87 | 17.74 | 46.01 | 0.933 |
| Test sample 7 | 13.83 | 18.21 | 45.78 | 0.945 |

It can be seen from analysis of Table 4 that different hydrogen storage alloy hydrides are favorable in improvement of grain boundary diffusion coercivity. When the same rare earth oxide is used, different hydrogen storage alloy hydrides may have varied impact on the magnetic performance of sintered NdFeB magnet subjecting to grain boundary diffusion.

### Embodiment 8

A method for improvement of magnetic performance of sintered NdFeB lamellar magnet includes the following steps:

\textcircled{1} Preparation of turbid liquid containing rare earth elements: The turbid liquid containing rare earth elements will be produced through mixing of Dy₂O₃ powder and CaH₂ powder for uniform distribution in the ethanol absolute; mass ratio between Dy₂O₃ powder and CaH₂ powder is 3:1;

\textcircled{2} Uniformly spray turbid liquid containing rare earth elements on the surface of sintered NdFeB lamellar magnet; ensure preliminary surface treatment to the sintered NdFeB lamellar magnet prior to spray coating;

\textcircled{3} Proceed with drying treatment to sintered NdFeB lamellar magnet after spray coating; drying treatment refers to heat preservation for 5 minutes at the temperature of 60° C.; store sintered NdFeB lamellar magnet in the atmosphere of inert gas after drying treatment;

\textcircled{4} Proceed with diffusion treatment to the sintered NdFeB lamellar magnet as dried in the vacuum environment at the pressure of 5×10⁻⁴ Pa prior to aging treatment; diffusion treatment temperature is 800° C.; diffusion treatment time is 16 h; aging treatment temperature is 500° C.; aging treatment time is 4 h.

In this embodiment, sintered NdFeB lamellar magnet is made from massive sintered NdFeB magnet through mechanical processing (cutting); its specification (diameter×thickness) is Φ10×7 mm; massive sintered NdFeB magnet is prepared based on such well-established processes as strip casting, hydrogen decrepitation, jet milling, pressing and sintering in the field of NdFeB fabrication; sintered NdFeB lamellar magnet includes the following constituents: Nd with mass percentage up to 24.5%, Dy with mass percentage up to 0.2%, Pr with mass percentage up to 4.8%, B with mass percentage up to 1.0%, residual Fe and other micro elements.

### Embodiment 9

This embodiment is basically identical to Embodiment 8; the only difference is stated as follows: In this embodiment, diffusion treatment temperature is 850° C.; diffusion treatment time is 20 h; aging treatment temperature is 500° C.; aging treatment time is 4 h.

### Embodiment 10

This embodiment is basically identical to Embodiment 8; the only difference is stated as follows: In this embodiment, diffusion treatment temperature is 890° C.; diffusion treatment time is 16 h; aging treatment temperature is 510° C.; aging treatment time is 4 h.

### Embodiment 11

This embodiment is basically identical to Embodiment 8; the only difference is stated as follows: In this embodiment, diffusion treatment temperature is 920° C.; diffusion treatment time is 6 h; aging treatment temperature is 510° C.; aging treatment time is 5 h.

Mark the sintered NdFeB lamellar magnet prepared with the method in Embodiment 8 as test sample 8; mark the sintered NdFeB lamellar magnet prepared with the method in Embodiment 9 as test sample 9; mark the sintered NdFeB lamellar magnet prepared with the method in Embodiment 10 as test sample 10; mark the sintered NdFeB lamellar magnet prepared with the method in Embodiment 11 as test sample 11; mark the sintered NdFeB lamellar magnet prior to spray coating as original sample. Select B-H instrument for measurement of permanent magnet material to carry out magnetic performance test for original sample 8-11 and test sample 8-11 respectively; magnetic performance test data is as shown in Table 5.

TABLE 5
Results of Performance Test for Sintered
NdFeB Lamellar Magnet in Embodiment 8-11

| | | | Maximum | |
|---|---|---|---|---|
| | | | Magnetic | |
| | | Intrinsic | Energy | |
| | remanence | Coercivity | Product | |
| | (KGs) | (KOe) | (MGsOe) | Squareness |
| Original sample | 13.99 | 14.88 | 46.61 | 0.96 |
| Test sample 8 | 13.93 | 17.10 | 46.21 | 0.932 |
| Test sample 9 | 13.92 | 17.8 | 46.23 | 0.937 |
| Test sample 10 | 13.91 | 18.34 | 46.26 | 0.936 |
| Test sample 11 | 13.86 | 18.22 | 45.88 | 0.922 |

It can be seen from analysis of Table 5 that different diffusion treatment and aging treatment temperature are favorable for improvement of grain boundary diffusion coercivity of sintered NdFeB lamellar magnet; furthermore, different diffusion treatment processes have different effects.

Viewing from aforesaid embodiments, we can see that the method according to the present invention can cover the surface of sintered NdFeB lamellar magnet with a layer of mixture composed of rare earth oxide and hydrogen storage alloy hydride. It is favorable for diffusion of rare earth elements into the sintered NdFeB lamellar magnet, which can effectively improve magnetic performance of sintered NdFeB lamellar magnet and utilization rate of rare earth elements.

1. A method for improvement of a magnetic performance of sintered NdFeB lamellar magnet, comprising:
First, a powder containing rare earth elements is to be coated on a surface of the sintered NdFeB lamellar magnet to form a finish coat;
after that, proceed with a diffusion treatment and an aging treatment to make rare earth elements as contained in the finish coat come into the sintered NdFeB lamellar magnet, wherein the powder containing rare earth elements belongs to a mixture of powder of rare earth oxide and hydrogen storage alloy hydride.

2. The method for improvement of magnetic performance of a sintered NdFeB lamellar magnet according to claim 1, wherein in the powder containing rare earth elements, mass percentage of the rare earth oxide powder and the hydrogen storage alloy hydride powder is 70%˜99.9% and 0.1%˜30% respectively.

3. The method for improvement of magnetic performance of a sintered NdFeB lamellar magnet according to claim 1, wherein the rare earth oxide is composed of one or at least two mixtures of oxide of scandium, yttrium and lanthanide.

4. The method for improvement of magnetic performance of a sintered NdFeB lamellar magnet according to claim 3, wherein the rare earth oxide is composed of one or at least two mixtures of oxide of dysprosium, terbium and holmium.

5. The method for improvement of magnetic performance of a sintered NdFeB lamellar magnet according to claim 1, wherein the hydrogen storage alloy hydride is composed of one or at least two mixtures of alkali hydride, alkali alloy hydride, alkali earth hydride, alkali earth alloy hydride, rare earth hydride and rare earth alloy hydride.

6. The method for improvement of magnetic performance of a sintered NdFeB lamellar magnet according to claim 5, wherein the hydrogen storage alloy hydride is composed of one or at least two mixtures of alkali earth hydride and rare earth hydride.

7. The method for improvement of magnetic performance of a sintered NdFeB lamellar magnet according to claim 1, wherein average grain size per specific area of the rare earth oxide powder is≤10 μm.

8. The method for improvement of magnetic performance of a sintered NdFeB lamellar magnet according to claim 1, wherein average grain size per specific area of the hydrogen storage alloy hydride powder is≤2 mm.

9. The method for improvement of magnetic performance of a sintered NdFeB lamellar magnet according to claim 8, wherein average grain size per specific area of the hydrogen storage alloy hydride powder is≤100 μm.

10. The method for improvement of magnetic performance of a sintered NdFeB lamellar magnet according to claim 1, wherein the diffusion treatment refers to heat preservation for 1 h-30 h at the temperature of 700° C.˜1000° C., the aging treatment refers to heat preservation for 1 h-10 h at the temperature of 400° C.˜600° C.
